(19) United States
(12) Patent Application Publication
(10) Pub. No.: US 2026/0268452 A1
(43) Pub. Date: Sep. 10, 2026

(54) APPARATUS AND METHOD FOR IMAGE ENHANCEMENT AND APPARATUS AND METHOD FOR TRAINING A MACHINE-LEARNING MODEL FOR IMAGE ENHANCEMENT

(71) Applicant: Sony Semiconductor Solutions Corporation, Atsugi-shi, Kanagawa (JP)

(72) Inventors: Saeed RAD, Stuttgart (DE); Mattia ROSSI, Stuttgart (DE); Gianluca AGRESTI, Stuttgart (DE); Henrik SCHÄFER, Stuttgart (DE); Diederik Paul MOEYS, Stuttgart (DE)

(73) Assignee: Sony Semiconductor Solutions Corporation, Atsugi-shi, Kanagawa (JP)

(21) Appl. No.: 19/167,398

(22) PCT Filed: Mar. 21, 2024
(86) PCT No.: PCT/EP2024/057667

§ 371 Date: Sep. 22, 2025

(30) Foreign Application Priority Data
Mar. 30, 2023 (EP) 23165314.8

(51) Int. Cl. G06T 5/60; G06T 3/4015; G06T 7/33; H04N 23/11; H04N 23/13

(52) U.S. Cl. CPC G06T 5/60; G06T 3/4015; G06T 7/337; H04N 23/11; H04N 23/13; G06T 2207/20081

(57) ABSTRACT

An apparatus for image enhancement is provided. The apparatus includes interface circuitry configured to receive first image data representing a multispectral image of a scene. The interface circuitry is further configured to receive second image data representing a first image of the scene in the visible light spectrum. In addition, the apparatus includes processing circuitry configured to generate, based on the multispectral image of the scene and the first image of the scene in the visible light spectrum and using a trained machine learning model for image enhancement, a second image of the scene in the visible light spectrum with at least one enhanced image property compared to the first image of the scene in the visible light spectrum.

### FIELD

The present disclosure relates to image enhancement. In particular, examples of the present disclosure relate to an apparatus and a method for image enhancement as well as an apparatus and a method for training a machine-learning model for image enhancement.

### BACKGROUND

The image enhancement problem is a traditional computer-vision problem used in various imaging applications. The main motivation is to process an image to increase its quality and become closer to reality (ground-truth) given the information within the initial image. One exemplary application of image enhancement is increasing the spatial resolution of given images or videos—namely image and video super-resolution.

There may be a demand for improved image enhancement.

### SUMMARY

This demand is met by an apparatus and a method for image enhancement, an apparatus and a method for training a machine-learning model for image enhancement, a non-transitory machine-readable medium, a program and a mobile phone in accordance with the independent claims. Advantageous embodiments are defined by the dependent claims.

According to a first aspect, the present disclosure provides an apparatus for image enhancement. The apparatus comprises interface circuitry configured to receive first image data representing a multispectral image of a scene. The interface circuitry is further configured to receive second image data representing a first image of the scene in the visible light spectrum. In addition, the apparatus comprises processing circuitry configured to generate, based on the multispectral image of the scene and the first image of the scene in the visible light spectrum and using a trained machine-learning model for image enhancement, a second image of the scene in the visible light spectrum with at least one enhanced image property compared to the first image of the scene in the visible light spectrum.

According to a second aspect, the present disclosure provides a method for image enhancement. The method comprises receiving first image data representing a multispectral image of a scene. Further, the method comprises receiving second image data representing a first image of the scene in the visible light spectrum. The method additionally comprises generating, based on the multispectral image of the scene and the first image of the scene in the visible light spectrum and using a trained machine-learning model for image enhancement, a second image of the scene in the visible light spectrum with at least one enhanced image property compared to the first image of the scene in the visible light spectrum.

According to a third aspect, the present disclosure provides ab apparatus for training a machine-learning model for image enhancement. The apparatus comprises processing circuitry configured to subject a first image of a scene output by the machine-learning model to image degradation processing to obtain a second image of the scene with at least one degraded image property compared to the first image. In addition, the processing circuitry is configured to modify the machine-learning model based on a difference between the first image and a third image output by the machine-learning model based on the second image of the scene and a multispectral image of the scene.

According to a fourth aspect, the present disclosure provides a method for training a machine-learning model for image enhancement. The method comprises subjecting a first image of a scene output by the machine-learning model to image degradation processing to obtain a second image of the scene with at least one degraded image property compared to the first image. In addition, the method comprises modifying the machine-learning model based on a difference between the first image and a third image output by the machine-learning model based on the second image of the scene and a multispectral image of the scene.

According to a fifth aspect, the present disclosure provides a non-transitory machine-readable medium having stored thereon a program having a program code for performing the method according to the second or the fourth aspect, when the program is executed on a processor or a programmable hardware.

According to a sixth aspect, the present disclosure provides a program having a program code for performing the method according to the second or the fourth aspect, when the program is executed on a processor or a programmable hardware.

According to a sixth aspect, the present disclosure provides a mobile phone comprising the apparatus for image enhancement according to the first aspect.

### BRIEF DESCRIPTION OF THE FIGURES

Some examples of apparatuses and/or methods will be described in the following by way of example only, and with reference to the accompanying figures, in which

FIG. 1 schematically illustrates an exemplary apparatus for image enhancement;

FIG. 2 illustrates a first exemplary data flow for image enhancement;

FIG. 3 illustrates a second exemplary data flow for image enhancement;

FIG. 4 illustrates a flowchart of an example of a method for image enhancement;

FIG. 5 schematically illustrates an exemplary apparatus for training a machine-learning model for image enhancement; and

FIG. 6 illustrates a flowchart of an example of a method for training a machine-learning model for image enhancement.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

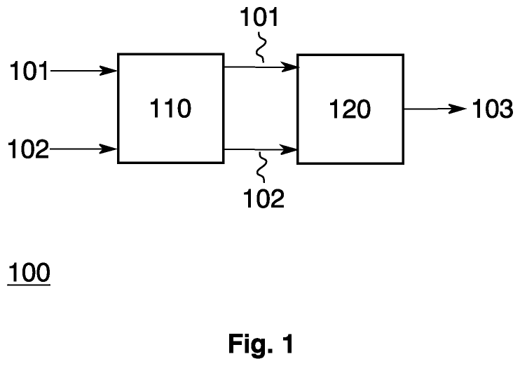

FIG. 1 schematically illustrates an exemplary apparatus 100 for image enhancement.

The apparatus 100 comprises at least interface circuitry 110 and processing circuitry 120. The processing circuitry 120 is coupled to the interface circuitry 110.

The interface circuitry 110 is configured to receive first image data 101 representing (indicating, encoded with) a multispectral image of a scene. The multispectral image is a collection of a plurality of image layers (i.e. N≥2 image layers) of the same scene (i.e. the surface 130), each of them acquired at a particular wavelength or wavelength range (band). In other words, the multispectral image depicts the same scene (i.e. the surface 130) at a plurality of different wavelengths or wavelength ranges (i.e. N≥2 different wavelengths or wavelength ranges). The wavelengths or wavelength ranges may, e.g., be in the ultraviolet light spectrum (wavelength from approx. 100 nm to approx. 380 nm), visible light spectrum (wavelength from approx. 380 nm to approx. 780 nm) and the infrared light spectrum (wavelength from approx. 780 nm to approx. 1 mm). In particular, at least one of the wavelength ranges may be outside the visible light spectrum. The multispectral image comprises a plurality of pixels (i.e. M≥2 pixels) representing (indicating, encoded with) the spectral data.

The interface circuitry 110 is further configured to receive second image data 102 representing a first image of the scene in the visible light spectrum. For example, the first image of the scene in the visible light spectrum may be a Red-Green-Blue (RGB) image representing the scene in the RGB color model. RGB images are also known as “true color images”. However, the present disclosure is not limited to RGB images, also image types using color models different from the RGB color model such as the Hue-Saturation-Lightness (HSL) color model or Hue-Saturation-Value (HSV) color model may be used.

The multispectral image as well as the first image of the scene in the visible light spectrum may be photographs (i.e., images created by light falling on a photosensitive surface such as a photographic film or an image sensor) or still frames of a recorded video (i.e. single static images taken from a series of recorded still images forming the recorded video).

The first image data 101 and the second image 102 may be received from various sources. For example, a multispectral imaging sensor may be configured to capture the scene and generate the first image data 101. The multispectral imaging sensor may be sensitive to at least one of ultraviolet light (i.e., light in the ultraviolet light spectrum), infrared light (i.e., light in the infrared light spectrum) and visible light ((i.e., light in the visible light spectrum). Similarly, a visible imaging sensor may be configured to capture the scene and generate the second image data 102. The visible imaging sensor is sensitive to visible light (i.e., light in the visible light spectrum). The apparatus 100 may comprise the multispectral imaging sensor and the visible imaging sensor according to examples of the present disclosure. However, the present disclosure is not limited thereto. Therefore, in other examples, the multispectral imaging sensor and the visible imaging sensor may be external to (separate from) the apparatus 100.

The processing circuitry 120 is configured to receive and further process the multispectral image of the scene and the first image of the scene in the visible light spectrum. For example, the processing circuitry 120 may be a single dedicated processor, a single shared processor, or a plurality of individual processors, some of which or all of which may be shared, a digital signal processor (DSP) hardware, an application specific integrated circuit (ASIC), a neuromorphic processor or a field programmable gate array (FPGA). The processing circuitry 120 may optionally be coupled to, e.g., memory such as read only memory (ROM) for storing software, random access memory (RAM) and/or non-volatile memory. For example, the apparatus 100 may comprise memory configured to store instructions, which when executed by the processing circuitry 120, cause the processing circuitry 120 to perform the steps and methods described herein.

The processing circuitry 120 is configured to generate a second image 103 of the scene in the visible light spectrum with at least one enhanced image property compared to the first image of the scene in the visible light spectrum. The processing circuitry 120 is configured to generate the second image 103 of the scene in the visible light spectrum based on the multispectral image of the scene and the first image of the scene in the visible light spectrum. Furthermore, the processing circuitry 120 is configured to generate the second image 103 of the scene in the visible light spectrum using a trained machine-learning model for image enhancement. An image property is a specific characteristic of an image that allows to describe the image. For example, image resolution, colors, noise and dynamic range are exemplary properties of an image. Accordingly, the at least one enhanced image property may, e.g., be one or more of increased image resolution, refined colors, reduced noise, reduced blur and increased dynamic range. However, the present disclosure is not limited thereto. Other image properties may be enhanced as well. The second image 103 of the scene in the visible light spectrum may, e.g., be an RGB image. However, the present disclosure is not limited to RGB images, also image types using color models different from the RGB color model such as the HSL color model or HSV color model may be used.

The apparatus 100 may allow to leverage information in the multispectral image of the scene to enhance one or more image properties of the first image of the scene in the visible light spectrum. The multispectral image of the scene comprises information about the scene in spectral regions different from those of the first image of the scene in the visible light spectrum. By using the multispectral image in addition to the first image of the scene in the visible light spectrum, new information is provided to the reconstruction process for generating the second image 103 of the scene in the visible light spectrum, which is not accessible from the first image of the scene in the visible light spectrum alone. Accordingly, the image enhancement by the machine-learning model may be leveraged with the additional information from the multispectral image.

The machine-learning model is a data structure and/or set of rules representing a statistical model that the processing circuitry 120 uses to generate the second image 103 of the scene in the visible light spectrum without using explicit instructions, instead relying on models and inference. The data structure and/or set of rules represents learned knowledge (e.g. based on training performed by a machine-learning algorithm as described above and below). In machine-learning, instead of a rule-based transformation of data, a transformation of data may be used, that is inferred from an analysis of training data.

The machine-learning model is trained by a machine-learning algorithm. The term “machine-learning algorithm” denotes a set of instructions that are used to create, train or use a machine-learning model. For the machine-learning model to generate the second image 103 of the scene in the visible light spectrum, the machine-learning model may be trained using training data such as training images in the visible light spectrum and corresponding training multispectral images as input and predefined image enhanced images in the visible light spectrum as target output. By training the machine-learning model with a large set of training data and associated training content information, the machine-learning model “learns” how to generate images of the scene in the visible light spectrum with enhanced image properties from the training data, so that a target image of the scene in the visible light spectrum with enhanced image properties can be obtained using the machine-learning model. By training the machine-learning model using training images in the visible light spectrum, corresponding training multispectral images and image enhanced images in the visible light spectrum, the machine-learning model “learns” a transformation between the input images and the desired output, which can be used to provide an output based on non-training images in the visible light spectrum and corresponding non-training multispectral images provided to the machine-learning model.

The machine-learning model may be trained using training input data (e.g., training images in the visible light spectrum and corresponding training multispectral images). For example, the machine-learning model may be trained using a training method called “supervised learning”. In supervised learning, the machine-learning model is trained using a plurality of training samples, wherein each sample may comprise a plurality of input data values, and a plurality of desired output values, i.e., each training sample is associated with a desired output value. By specifying both training samples and desired output values, the machine-learning model “learns” which output value to provide based on an input sample that is similar to the samples provided during the training. For example, a training sample may comprise one or more training images in the visible light spectrum and one or more corresponding training multispectral images as input data and one or more image enhanced images in the visible light spectrum as desired output data.

Apart from supervised learning, semi-supervised learning may be used. In semi-supervised learning, some of the training samples lack a corresponding desired output value. Supervised learning may be based on a supervised learning algorithm (e.g., a classification algorithm or a similarity learning algorithm). Classification algorithms may be used as the desired outputs of the trained machine-learning model are restricted to a limited set of values (categorical variables), i.e., the input is classified to one of the limited set of values (e.g., images in the in the visible light spectrum with certain features, noise levels, resolutions, etc.). Similarity learning algorithms are similar to classification algorithms but are based on learning from examples using a similarity function that measures how similar or related two objects are.

Apart from supervised or semi-supervised learning, unsupervised learning may be used to train the machine-learning model. In unsupervised learning, (only) input data are supplied and an unsupervised learning algorithm is used to find structure in the input data such as training images in the visible light spectrum and one or more corresponding training multi-spectral images. Clustering is the assignment of input data comprising a plurality of input values into subsets (clusters) so that input values within the same cluster are similar according to one or more (pre-defined) similarity criteria, while being dissimilar to input values that are included in other clusters. The input data for the unsupervised learning may be one or more training images in the visible light spectrum and one or more corresponding training multispectral images.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such that the cumulative reward is increased, leading to software agents that become better at the task they are given (as evidenced by increasing rewards).

Furthermore, additional techniques may be applied to some of the machine-learning algorithms. For example, feature learning may be used. In other words, the machine-learning model may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

For example, the machine-learning model may be an Artificial Neural Network (ANN). ANNs are systems that are inspired by biological neural networks, such as can be found in a retina or a brain. ANNs comprise a plurality of interconnected nodes and a plurality of connections, so-called edges, between the nodes. There are usually three types of nodes, input nodes that receiving input values (e.g., an image in the visible light spectrum and a corresponding multispectral image), hidden nodes that are (only) connected to other nodes, and output nodes that provide output values (e.g., an image enhanced image in the visible light spectrum). Each node may represent an artificial neuron. Each edge may transmit information from one node to another. The output of a node may be defined as a (non-linear) function of its inputs (e.g. of the sum of its inputs). The inputs of a node may be used in the function based on a “weight” of the edge or of the node that provides the input. The weight of nodes and/or of edges may be adjusted in the learning process. In other words, the training of an ANN may comprise adjusting the weights of the nodes and/or edges of the ANN, i.e., to achieve a desired output for a given input.

Alternatively, the machine-learning model may be a support vector machine, a random forest model or a gradient boosting model. Support vector machines (i.e. support vector networks) are supervised learning models with associated learning algorithms that may be used to analyze data (e.g. in classification or regression analysis). Support vector machines may be trained by providing an input with a plurality of training input values (e.g., training images in the visible light spectrum) that belong to one of two categories (e.g., blurry and non-blurry images or noisy and non-noisy images). The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

In some examples, the machine-learning model may be a combination of the above examples.

The first image data 101 may be raw data of the multispectral imaging sensor according to examples of the present disclosure. Accordingly, the processing circuitry 120 may be further configured to subject the first image data 101 to demosaicing processing (also known as debayering processing) to obtain the multispectral image. In other words, the processing circuitry 120 may be configured to perform demosaicing processing on the first image data 101 to obtain the multispectral image. In the demosaicing processing, the processing circuitry reconstructs the full multispectral image from the output samples of the multispectral imaging sensor, which are included in the first image data 101. In some examples, the trained machine-learning model may be trained to perform the demosaicing processing. That is, the demosaicing processing may be performed using the trained machine-learning model. In these examples, the first image data 101, i.e., the raw data of the multispectral imaging sensor may be input to the trained machine-learning model. However, the present disclosure is not limited thereto. In other words, the demosaicing processing may be performed before the multispectral image is input to the trained machine-learning model.

The multispectral imaging sensor and the visible imaging sensor capture the scene from (slightly) different angles. As a consequence, the multispectral image of the scene and the first image of the scene in the visible light spectrum depict the scene from (slightly) different angles. Accordingly, the processing circuitry 120 may be configured to subject the multispectral image of the scene and the first image of the scene in the visible light spectrum to image alignment processing (also known as image registration processing) in order to align the multispectral image of the scene and the first image of the scene in the visible light spectrum. In other words, the processing circuitry 120 may be configured to perform image alignment processing on the multispectral image of the scene and the first image of the scene in the visible light spectrum. The image alignment processing may, e.g., comprise translations, rotations, and scaling to minimize the differences between corresponding points or pixels in both images. The image alignment processing allows to compensate for the (slightly) different capturing angles of the multispectral image of the scene and the first image of the scene in the visible light spectrum. Accordingly, the second image 103 of the scene in the visible light spectrum may be generated based on the aligned multispectral image of the scene rather than the initial multispectral image of the scene. In some examples, the trained machine-learning model may be trained to perform the alignment processing. That is, the alignment processing may be performed using the trained machine-learning model. However, the present disclosure is not limited thereto. For example, the alignment processing may be performed and the resulting aligned multispectral image may be input to the trained machine-learning model.

Feature extraction processing may be used to identify and extract information (denoted as “features”) from the aligned multispectral image of the scene. The extracted features may be used by the trained machine-learning model in the process of generating the second image 103 of the scene in the visible light spectrum to enhance the one or more image properties of the first image of the scene in the visible light spectrum. Accordingly, the processing circuitry 120 may be configured to subject the aligned multispectral image of the scene to feature extraction processing to extract one or more features from the multispectral image of the scene. In other words, the processing circuitry 120 may be configured to perform feature extraction processing on the aligned multispectral image of the scene. The feature extraction processing allows to reduce the amount of data of the aligned multispectral image of the scene while retaining the most useful information (features) for the generation of the second image 103 of the scene in the visible light spectrum. For example, features extracted from the aligned multispectral image of the scene may allow to determine or predict conditions of objects in the scene, classify materials of objects in the scene, etc. In general, the features extracted from the aligned multispectral image of the scene may allow to determine or predict properties of the scene which are not visible or extractable from the first image of the scene in the visible light spectrum. In other words, the feature extraction processing may allow to identify and extract multispectral information (features), i.e., information or features which is/are not accessible from the first image of the scene in the visible light spectrum alone. Accordingly, the second image 103 of the scene in the visible light spectrum may be generated by the trained machine-learning model based on the one or more extracted features.

In some examples, the trained machine-learning model may be trained to perform the feature extraction processing. That is, the feature extraction processing may be performed using the trained machine-learning model. However, the present disclosure is not limited thereto. For example, the feature extraction processing may be performed and the one or more extracted features may be input to the trained machine-learning model. In other examples, a separate trained machine-learning model for feature extraction may be used. The person skilled in the art is familiar with machine-learning models for feature extraction from multispectral images. Therefore, no further details about the structure and the training of such machine-learning models will be given in the context of this specification.

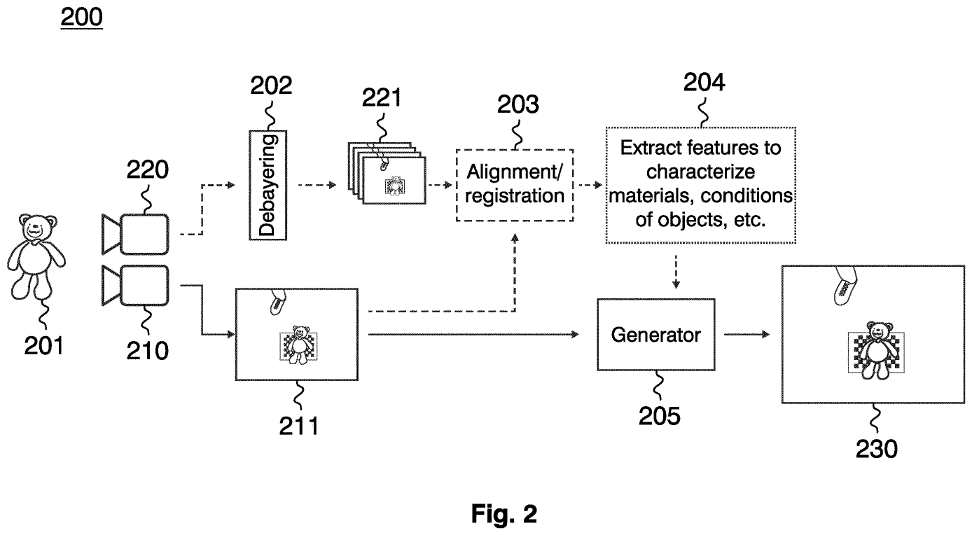

FIG. 2 illustrates a first exemplary data flow 200 for image enhancement according to at least some of the aspects described above.

A visible imaging sensor 210 (e.g., an RGB imaging sensor) and a multispectral imaging sensor 220 capture a scene 201. The visible imaging sensor 210 outputs a corresponding first image 211 of the scene in the visible light spectrum. Demosaicing processing 202 such as debayering processing is performed on the raw data (i.e., the output data) of the multi-spectral imaging sensor 220 to obtain a multispectral image 221 of the scene. In other words, each sensor 210, 220 simultaneously captures an image of the scene 201. As the images 211 and 221 are taken from different positions in space, alignment processing 203 is performed to align the two images 211 and 221 spatially with each other. As described above, the demosaicing processing 202 and the alignment processing 203 described in the foregoing may be based on a trained machine-learning model.

Then, feature extraction processing 204 is performed to explore the registered multispectral image and extract multispectral features. The multispectral features may, e.g., be used in the feature extraction processing 204 to determine or predict conditions of objects, classify materials, etc. The feature extraction processing 204 allows to determine or predict properties of the scene/objects which are not visible to/extractable by visible imaging sensor 210. As described above, the feature extraction processing 204 described in the foregoing may be based on a trained machine-learning model.

Finally, a trained machine-learning model 205, which may be understood as a learning-based generator, is used to explore both the extracted multispectral-related features and the original first image of the scene in the visible light spectrum (e.g., an RGB image) to generate a second image 230 of the scene in the visible light spectrum with at least one enhanced image property compared to the first image 211 of the scene. For example, the second image 230 of the scene in the visible light spectrum may be an enhanced RGB image.

In case, one of the processing steps is based on machine-learning, the respective model may be trained as described above (e.g., in a supervised fashion).

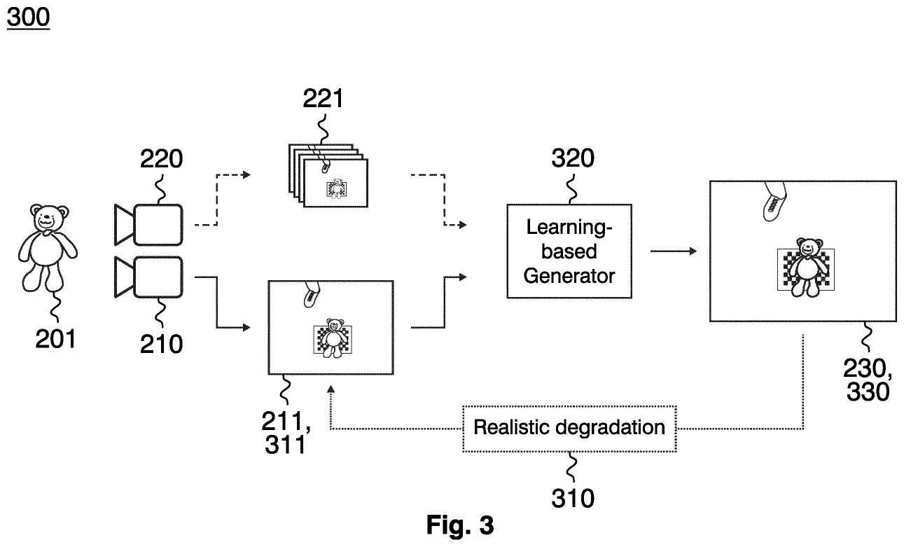

The processing illustrated in FIG. 2 may in some example of the present disclosure be performed by a single trained machine-learning model. This is exemplarily illustrated in FIG. 3 which illustrates a second data flow 300 for image enhancement according to at least some of the aspects described above.

Like in the example of FIG. 2, the visible imaging sensor 210 and the multispectral imaging sensor 220 capture the scene 201. The first image 211 of the scene in the visible light spectrum as output by the visible imaging sensor 210 is input to the trained machine-learning model 321. Similarly, the raw data 321 of the multispectral imaging sensor 220, which represent the multispectral image 221 of the scene 201, are input to the trained machine-learning model 320.

The trained machine-learning model 320 is trained to perform the demosaicing processing 202, the alignment processing 203, the feature extraction processing 204 and the generation of the second image 230 of the scene in the visible light spectrum as described above with respect to FIG. 2.

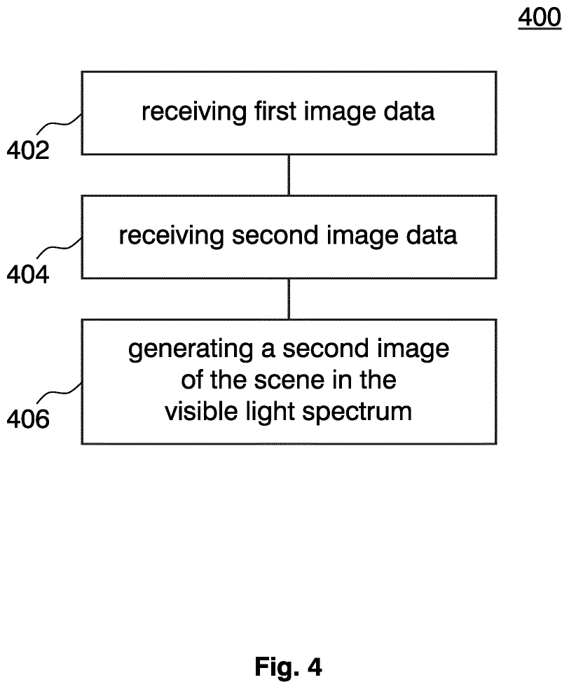

For further highlighting the image enhancement described above, FIG. 4 illustrates a flowchart of a method 400 for image enhancement. The method 400 comprises receiving 402 first image data representing a multispectral image of a scene. Further, the method 400 comprises receiving 404 second image data representing a first image of the scene in the visible light spectrum. The method 400 additionally comprises generating 406, based on the multispectral image of the scene and the first image of the scene in the visible light spectrum and using a trained machine-learning model for image enhancement, a second image of the scene in the visible light spectrum with at least one enhanced image property compared to the first image of the scene in the visible light spectrum.

Analogously to what is described above, the method 400 may allow to leverage information in the multispectral image of the scene to enhance one or more image properties of the first image of the scene in the visible light spectrum.

More details and aspects of the method 400 are explained in connection with the proposed technique or one or more examples described above (e.g., FIG. 1 to FIG. 3). The method 400 may comprise one or more additional optional features corresponding to one or more aspects of the proposed technique or one or more examples described above. For example, the method 400 may further comprise demosaicing, alignment and feature extraction as described above.

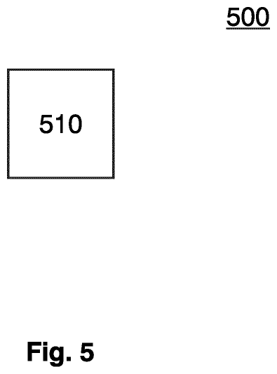

The machine-learning model for image enhancement may be trained using various training techniques (see above). In the following, a non-limiting training approach based on unsupervised learning is described with reference to FIG. 5. FIG. 5 illustrates an apparatus 500 for training a machine-learning model for image enhancement. The apparatus comprises processing circuitry 510. The processing circuitry 510 may be like the processing circuitry 120 described above.

The processing circuitry 510 is configured to subject a first image of a scene output by the machine-learning model to image degradation processing. In other words, the processing circuitry 510 is configured to perform image degradation processing on the first image. The image degradation processing may be any processing that degrades (reduces, worsens) an image property of the first image of the scene. For example, the image degradation processing may comprise at least one of image resolution reduction, color degradation, noise introduction (noise increasement), dynamic range reduction, blurring, warping. However, the present disclosure is not limited thereto. Other image properties may be degraded as well. A second image of the scene with at least one degraded image property compared to the first image is obtained from the image degradation processing.

The processing circuitry 510 is further configured to modify the machine-learning model based on a difference between the first image and a third image output by the machine-learning model. The third image is output by the machine-learning model based on the second image of the scene and a multispectral image of the scene. In other words, the second image of the scene and the multispectral image of the scene are input to the machine-learning model and the third image is the corresponding output by the machine-learning model. In particular, the processing circuitry 510 is configured to modify the machine-learning model such that the difference between the first image and the third image is minimized. For example, the processing circuitry 510 may be configured to modify one or more weights of the machine-learning model or add or delete one or more nodes to the machine-learning model based on the difference between the first image and the third image.

The above processing by the processing circuitry 510 may be performed iteratively to gradually train and refine the machine-learning model based on its outputs.

The apparatus 510 may allow to obtain a trained machine-learning model for image enhancement. For example, the apparatus 510 may be used to train the machine-learning model used in the above examples for image enhancement.

The processing circuitry 510 may be configured to determine the difference between the first image and the third image. For example, the processing may be configured to compare one or more image properties of the first image and the third image to determine the difference between the first image and the third image. Accordingly, the machine-learning model may be modified to minimize the differences between the first image and the third image with respect to the one or more image properties.

The above described training is further indicated in the data flow 300 illustrated in FIG. 3. The second image 230 of the scene in the visible light spectrum as output by the machine-learning model 320 is subjected to an image degradation processing 310 to obtain a degraded image 311 with one or more degraded image properties. For example, the image degradation processing 310 may include a down-sampling operator to create an artificial low-resolution image 311 from the already high-resolution image 230. The degraded image 311 is then input to the machine-learning model 320 instead of the image 211 output by the visible imaging sensor 210. The degraded image 311 is input to the machine-learning model 320 together with the raw data 321 of the multispectral imaging sensor 220. Accordingly, the machine-learning model 320 outputs another image 330 in the visible light spectrum. Based on the comparison of the images 230 and 330, the machine-learning model 320 is modified to learn the mapping between input images 211, 311 in the visible light range and the output images 230, 330 in the visible light spectrum while having multispectral input data 321 at disposal.

According to example of the present disclosure, image degradation processing may further be applied to the raw data 321, i.e., the multispectral data of the multispectral imaging sensor 220 at the training phase.

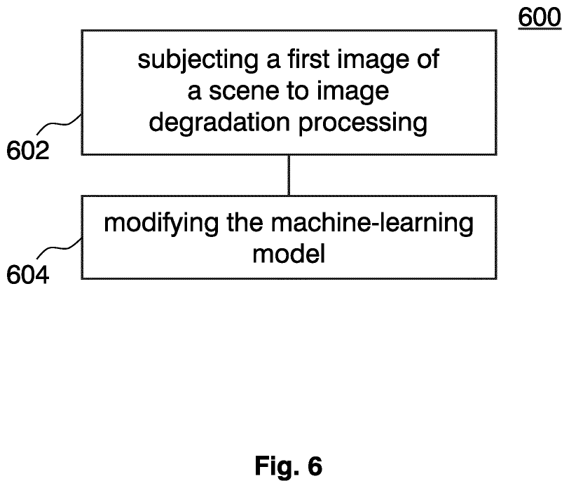

For further highlighting the training of a machine-learning model for image enhancement described above, FIG. 6 illustrates a flowchart of a method 600 for training a machine-learning model for image enhancement. The method 600 comprises subjecting 602 a first image of a scene output by the machine-learning model to image degradation processing to obtain a second image of the scene with at least one degraded image property compared to the first image. In addition, the method 600 comprises modifying 604 the machine-learning model based on a difference between the first image and a third image output by the machine-learning model based on the second image of the scene and a multispectral image of the scene.

Analogously to what is described above, the method 600 may allow to obtain a trained machine-learning model for image enhancement.

More details and aspects of the method 600 are explained in connection with the proposed technique or one or more examples described above (e.g., FIG. 1 to FIG. 5). The method 600 may comprise one or more additional optional features corresponding to one or more aspects of the proposed technique or one or more examples described above.

The present disclosure provides a learning-based approach for image enhancement by leveraging multispectral features.

The image enhancement as described above may be used for any imaging device. For example, the image enhancement may be used in mobile phones, tablet-computers, laptop-computers or digital cameras. Furthermore, the image enhancement as described above may be used in servers (e.g., of a computing cloud) to provide a remote image enhancement service for client devices (e.g., mobile phones or tablet-computers) generating the first image data and the second image data.

The following examples pertain to further embodiments:
(1) An apparatus for image enhancement, the apparatus comprising: interface circuitry configured to:
receive first image data representing a multispectral image of a scene; and
receive second image data representing a first image of the scene in the visible light spectrum; and
processing circuitry configured to generate, based on the multispectral image of the scene and the first image of the scene in the visible light spectrum and using a trained machine-learning model for image enhancement, a second image of the scene in the visible light spectrum with at least one enhanced image property compared to the first image of the scene in the visible light spectrum.
(2) The apparatus of (1), wherein the processing circuitry is further configured to subject the first image data to demosaicing processing to obtain the multispectral image.
(3) The apparatus of (2), wherein the trained machine-learning model is trained to perform the demosaicing processing.
(4) The apparatus of any one of (1) to (3), wherein the processing circuitry is configured to subject the multispectral image of the scene and the first image of the scene in the visible light spectrum to image alignment processing to align the multispectral image of the scene and the first image of the scene in the visible light spectrum, and wherein the second image of the scene in the visible light spectrum is generated based on the aligned multispectral image of the scene.
(5) The apparatus of (4), wherein the trained machine-learning model is trained to perform the alignment processing.
(6) The apparatus of (4) or (5), wherein the processing circuitry is further configured to subject the aligned multispectral image of the scene to feature extraction processing to extract one or more features from the multispectral image of the scene, and wherein the second image of the scene in the visible light spectrum is generated by the trained machine-learning model based on the one or more extracted features.
(7) The apparatus of (6), wherein the trained machine-learning model is trained to perform the feature extraction processing.
(8) The apparatus of any one of (1) to (7), wherein the multispectral image of the scene comprises a plurality of image layers depicting the scene at different wavelength ranges, wherein at least one of the wavelength ranges is outside the visible light spectrum.
(9) The apparatus of any one of (1) to (8), wherein the at least one enhanced image property is one or more of increased image resolution, refined colors, reduced noise, and increased dynamic range.
(10) The apparatus of any one of (1) to (9), further comprising:
a multispectral imaging sensor configured to capture the scene and generate the first image data, wherein the multispectral imaging sensor is sensitive to at least one of ultraviolet light and infrared light; and
a visible imaging sensor configured to capture the scene and generate the second image data, wherein the visible imaging sensor is sensitive to visible light.
(11) A method for image enhancement, the method comprising:
receiving first image data representing a multispectral image of a scene;
receiving second image data representing a first image of the scene in the visible light spectrum; and
generating, based on the multispectral image of the scene and the first image of the scene in the visible light spectrum and using a trained machine-learning model for image enhancement, a second image of the scene in the visible light spectrum with at least one enhanced image property compared to the first image of the scene in the visible light spectrum.
(12) An apparatus for training a machine-learning model for image enhancement, the apparatus comprising processing circuitry configured to:
subject a first image of a scene output by the machine-learning model to image degradation processing to obtain a second image of the scene with at least one degraded image property compared to the first image;
modify the machine-learning model based on a difference between the first image and a third image output by the machine-learning model based on the second image of the scene and a multispectral image of the scene.
(13) A method for training a machine-learning model for image enhancement, the method comprising:
subjecting a first image of a scene output by the machine-learning model to image degradation processing to obtain a second image of the scene with at least one degraded image property compared to the first image;
modifying the machine-learning model based on a difference between the first image and a third image output by the machine-learning model based on the second image of the scene and a multispectral image of the scene.
(14) A non-transitory machine-readable medium having stored thereon a program having a program code for performing the method according to (11) or (13), when the program is executed on a processor or a programmable hardware.
(15) A program having a program code for performing the method according to (11) or (13), when the program is executed on a processor or a programmable hardware.
(16) A mobile phone comprising an apparatus for image enhancement according to any one of (1) to (10).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), ASICs, integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for image enhancement, the apparatus comprising:
interface circuitry configured to:
receive first image data representing a multispectral image of a scene; and
receive second image data representing a first image of the scene in the visible light spectrum; and
processing circuitry configured to generate, based on the multispectral image of the scene and the first image of the scene in the visible light spectrum and using a trained machine-learning model for image enhancement, a second image of the scene in the visible light spectrum with at least one enhanced image property compared to the first image of the scene in the visible light spectrum.

2. The apparatus of claim 1, wherein the processing circuitry is further configured to subject the first image data to demosaicing processing to obtain the multispectral image.

3. The apparatus of claim 2, wherein the trained machine-learning model is trained to perform the demosaicing processing.

4. The apparatus of claim 1, wherein the processing circuitry is configured to subject the multispectral image of the scene and the first image of the scene in the visible light spectrum to image alignment processing to align the multispectral image of the scene and the first image of the scene in the visible light spectrum, and wherein the second image of the scene in the visible light spectrum is generated based on the aligned multispectral image of the scene.

5. The apparatus of claim 4, wherein the trained machine-learning model is trained to perform the alignment processing.

6. The apparatus of claim 4, wherein the processing circuitry is further configured to subject the aligned multispectral image of the scene to feature extraction processing to extract one or more features from the multispectral image of the scene, and wherein the second image of the scene in the visible light spectrum is generated by the trained machine-learning model based on the one or more extracted features.

7. The apparatus of claim 6, wherein the trained machine-learning model is trained to perform the feature extraction processing.

8. The apparatus of claim 1, wherein the multispectral image of the scene comprises a plurality of image layers depicting the scene at different wavelength ranges, wherein at least one of the wavelength ranges is outside the visible light spectrum.

9. The apparatus of claim 1, wherein the at least one enhanced image property is one or more of increased image resolution, refined colors, reduced noise, and increased dynamic range.

10. The apparatus of claim 1, further comprising:
a multispectral imaging sensor configured to capture the scene and generate the first image data, wherein the multispectral imaging sensor is sensitive to at least one of ultraviolet light and infrared light; and
a visible imaging sensor configured to capture the scene and generate the second image data, wherein the visible imaging sensor is sensitive to visible light.

11. A method for image enhancement, the method comprising:
receiving first image data representing a multispectral image of a scene;
receiving second image data representing a first image of the scene in the visible light spectrum; and
generating, based on the multispectral image of the scene and the first image of the scene in the visible light spectrum and using a trained machine-learning model for image enhancement, a second image of the scene in the visible light spectrum with at least one enhanced image property compared to the first image of the scene in the visible light spectrum.

12. An apparatus for training a machine-learning model for image enhancement, the apparatus comprising processing circuitry configured to:
subject a first image of a scene output by the machine-learning model to image degradation processing to obtain a second image of the scene with at least one degraded image property compared to the first image;
modify the machine-learning model based on a difference between the first image and a third image output by the machine-learning model based on the second image of the scene and a multispectral image of the scene.

13. A method for training a machine-learning model for image enhancement, the method comprising:
subjecting a first image of a scene output by the machine-learning model to image degradation processing to obtain a second image of the scene with at least one degraded image property compared to the first image;
modifying the machine-learning model based on a difference between the first image and a third image output by the machine-learning model based on the second image of the scene and a multispectral image of the scene.

14. A non-transitory machine-readable medium having stored thereon a program having a program code for performing the method according to claim 11, when the program is executed on a processor or a programmable hardware.

15. A program having a program code for performing the method according to claim 11, when the program is executed on a processor or a programmable hardware.

16. A mobile phone comprising an apparatus for image enhancement according to claim 1.
